(19) United States
(12) Patent Application Publication
(10) Pub. No.: US 2007/0258800 A1
(43) Pub. Date: Nov. 8, 2007

(54) Two pivot point dump rack

(76) Inventor: Michael F. Mistler, Jefferson City, MO (US)

Correspondence Address: Richard Grundstrom, P.O. Box 26, Holts Summit, MO, 65043, US

(21) Appl. No.: 11/416,779

(22) Filed: May 3, 2006

(51) Int. Cl. B65F 3/02

(52) U.S. Cl. 414/408

(57) ABSTRACT

Two embodiments are described. Both use only two pivot points. Both have a fixed frame having side members and a cross member attachable to the top edge of the pickup bed. One embodiment uses a pivoting frame pivotally attached to the side members. Upright supports are rigidly attached to the forward end of the pivoting frame. A dump rack is rigidly attached to the top of the upright supports. The dump rack is tilted by the pivoting the pivoting frame. The second embodiment has the upright supports rigidly attached to a forward end of the fixed frame. Longitudinal arms are rigidly attached to the top of the upright supports. The dump rack is pivotally attached to the longitudinal arms. Actuators, dampers, or other lifting devices can be used to assist in tilting or lifting the pivoting frame and/or the dump rack.

### BACKGROUND OF THE INVENTION

The present invention relates to an improved dump rack for mounting on a truck, trailer or the like and more particularly to a two pivot point dump rack mountable on a pickup truck and other type of vehicles.

U.S. Pat. No. 6,676,220, issued to Mistler, January 2004 describes a dump rack. There are a total of eight pivot points described. A pivoting frame, supporting the front portion of the rack, pivots from a pair of pivot points at a mid point on side members attached to side edges of the truck box. The rack itself has one pair of pivot points at a forward end of the dump rack and another pair of pivot points on the rear of the dump rack. The forward pivot points attach to a pivoting frame and the rear pivot points attach to legs. Then there is another pair of pivot points at the bottom of the legs. The present invention is an improvement over this dump rack. There are no rear pivot legs. The rack pivots in a different manner. The dump rack of this invention pivots from only one pair of pivot points.

Most racks mounted on pickup trucks have stationary frames attached to the side rails or side walls of the bed of the truck or trailer. Typically, the frames are made with forward uprights frame members and rear upright frame members (legs) with cross members joining the uprights. Longitudinal members extend between the forward and rear members to make a complete frame or rack. Other support members, additional legs, cross members, and attaching devices are incorporated on the frame based upon the particular application. As such, there are a wide variety and many configurations known and used. Many are factory made and many are custom made as needed. Other than the dump rack of Mistler, no truck racks have the ability to tilt or pivot the top frame to dump its load.

It is often difficult for one person to load or unload a rack, especially if the items are heavy, long or bulky. Often two or more persons are needed and used. Loading and unloading requires lifting weight from a low position to a high position or from a high position to a low position. Both loading and unloading are strenuous work which can result in injury. Moreover, items are often dropped when being loaded and unloaded. This can and does result in personal injury to the person performing the work, and property damage. Additionally, it can be time consuming to load and unload the rack, especially when articles are heavy or cumbersome and two or more persons are required. This results in expending expensive man-hours and possibilities of personal injury.

The improved dump rack of this invention overcomes several of the problems associated with fixed and stationary racks, and the prior mentioned dump rack. The rack dumps of this invention tilts for unloading or dumping its load utilizing only one pair of pivot points.

The rack of this invention requires a minimum amount of work and requires basically little if any physical exertion to unload items on the rack. The rack of this invention also reduces hazards when unloading. Since the rack dumps its load, there are no strenuous activities for the person unloading the rack. Since the user may operate the rack from a remote location, danger of items falling or hitting a person is greatly reduced.

Accordingly, it is an object of the present invention to provide an improved dump rack having a minimum number of pivot points adapted to dump its load with the load clearing the tailgate and rear of the truck. The dump rack of this invention only utilizes two pivot points. The dump rack of this invention will dump its load with the load clearing the rear of the truck by several inches.

Since there are no rear pivot legs and a minimum number of pivot points the load capacity of this improved dump rack is lower compared to the prior dump rack mentioned above. As such, another object of the present invention is to provide an improved dump rack that is constructed to provide a more economical, light duty, dump rack more suitable for the average pickup. The prior dump rack has a dump capacity that far exceeds the weight capacity of the truck. As such, the prior dump rack is a heavy duty commercial version for heavy duty trucks.

A further object of the present invention is to provide an improved dump rack with substantially less weight of the prior dump rack so the weight capacity of the truck is not adversely impacted by the weight of the dump rack.

Still, another object of the present invention is to provide an improved dump rack with a minimum number of a pivot point to reduce moving parts and location of failures. The Dump Rack of this invention only has one pair of pivot points thereby greatly reducing the number of pivot points.

Yet another object of this invention is to provide a safer dump rack for the operator and other persons. The rack of this invention is safer in that there are less moving parts and an area between the pivoting frame and the dumping rack that opens and closes when operated is eliminated. Thereby, eliminating at least one pinching location and reducing risk.

Another objective of the present invention is to provide a dump rack that can be provided as a kit to the consumer. The parts and components of this dump rack are designed to be assembled by bolting, or welding. As such, all the components can be easily shipped and the dump rack can than be assembled by the consumer.

To accomplish the foregoing and other objects of this invention there is provided an improved dump rack with a pair of pivot points described below and illustrated on the accompanying drawings.

### SUMMARY OF THE INVENTION

The improved dump rack of this invention includes a dump rack for attachment to pickups that is used to haul materials, tools or supplies. The dump rack of this invention is used as a regular pickup rack but has the provisions to dump the load.

Two embodiments are described. On both embodiments there is a fixed frame that attaches on the top edge of a pickup truck box or bed. The fixed frame has side members attachable to the top side edges of the pickup bed and a cross member that attaches to the forward end of the side members and fits across the front support of the box or bed of the truck.

On one embodiment there is a pivoting frame. A pair of pivot points is located toward the rear of the side members of the fixed frame. The pivoting frame has a pair of side rails, and a forward cross rail. The pivoting frame is sized to match and configured to engage the side members and cross member of the fixed frame. The rear end of the side rails of the pivoting frame is pivotally attached to the pivot points on the side members of the fixed frame. A pair of upright supports is attached to forward ends of the side rails on the pivoting frame. A dump rack consisting of longitudinal side members and cross members is rigidly attached to the top of the upright support members. This embodiment, the pivoting frame's forward end is lifted, pivoting the pivoting frame on the pair of pivot points, to raise and tilt the dump rack on the upright supports.

The second embodiment is a lighter duty dump rack that does not utilize a pivoting frame. The upright supports are rigidly attached to the forward ends of the side members on the fixed frame. Longitudinal arms are attached to the top of the upright supports parallel to the side members of the fixed frame. The pair of pivot points is located toward the rear of the longitudinal arms, rather than on the side members of the fixed frame. The dump rack is pivotally attached to the longitudinal arms so that only the rack pivots and tilts.

Both embodiments can be manually pivoted or pivoted using an electric, hydraulic, pneumatic or any other type of actuator or lifting device or mechanism. The manual version may be assisted by use of one or more damping device.

The above mentioned and other objects, and features of the present invention will be better understood and appreciated from the following detailed description of the main embodiment thereof, selected for purposes of illustration and shown in the accompanying drawings.

### BRIEF DESCRIPTION OF THE DRAWINGS

FIG. 1 shows a side view of one embodiment of the two pivot point dump rack with the pivoting frame and showing the rump rack in phantom in a raised position.

FIG. 1A is an exploded view of one embodiment with a pivoting frame showing all the various components.

FIG. 2 shows a side view of another embodiment of the two pivot point dump rack and showing the rump rack in phantom in a raised position.

FIG. 2A is an exploded view of the second embodiment showing all the various components.

FIG. 3 is an isotopic view showing a truck with the fixed frame, upright support, and longitudinal arms without a dump rack.

FIG. 4 shows the truck of FIG. 3 with the dump rack pivotally attached to the longitudinal arms.

FIG. 5 shows a representation of a damping device used to assist in raising and lowering the dump rack.

### DETAILED DESCRIPTION

Referring now to the drawings there is shown two of the preferred embodiments of the two pivot point dump rack of this invention. The first embodiment is generally referenced as 10 while the second embodiment is generally referenced as 12.

The first portion of the two pivot point dump rack 10 and 12 is a fixed frame 14 that attaches to a vehicle. Typically, the fixed frame 14 is attached to the side walls of the box or bed of a pickup truck 8, as shown and illustrated. The two pivot point dump rack of this invention could also be attached to a trailer or other type of vehicle.

The fixed frame 14 has a pair of side members 16 and 18, and a forward cross member 20 attached to the forward end of the side members 16 and 18 to form a frame sized to fit the box of the truck 8 or other vehicle or trailer. In the preferred embodiment as the best mode contemplated, the side members 16 and 18, and forward cross member 20 are made from steel angle iron sized in accordance with the application, cut, and welded and/or bolted together.

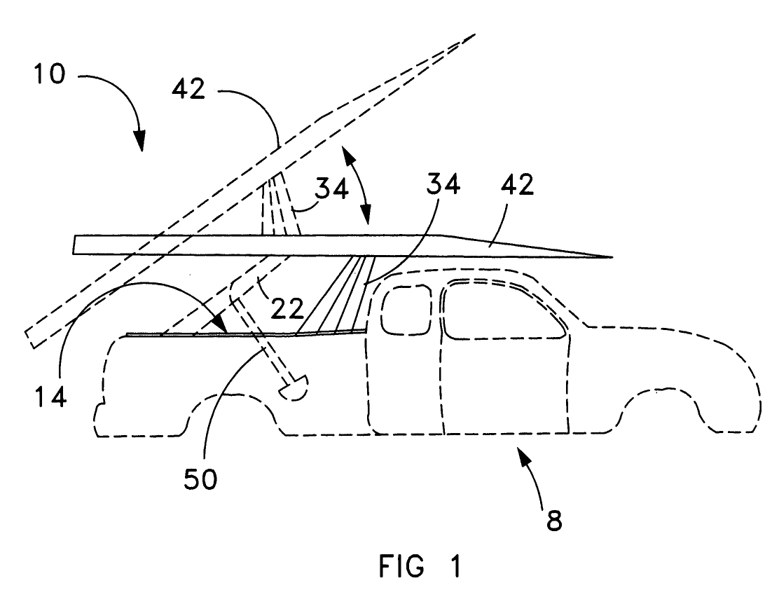

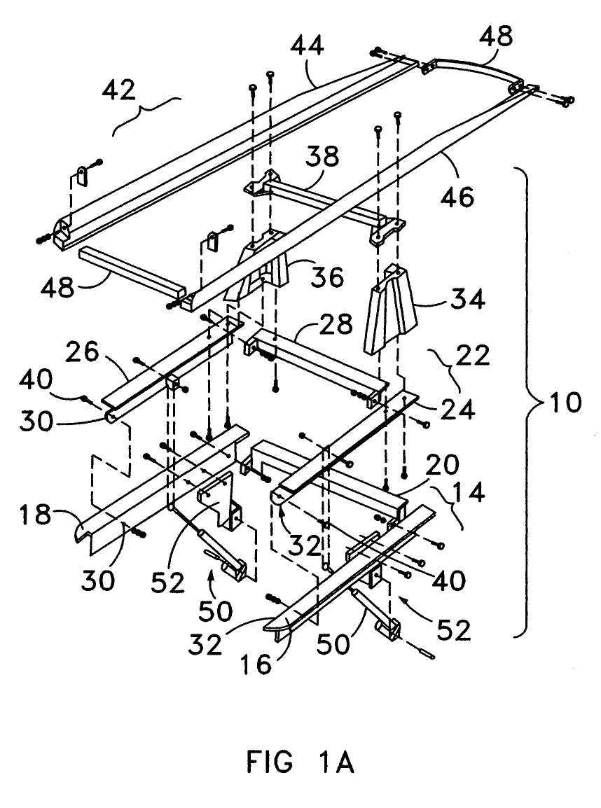

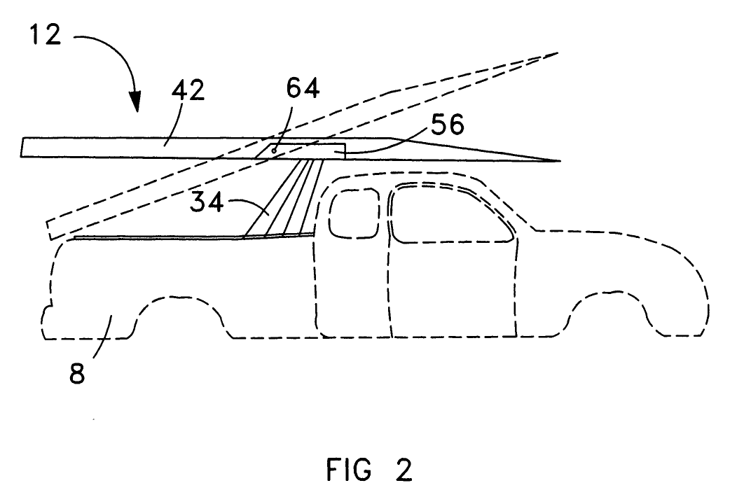

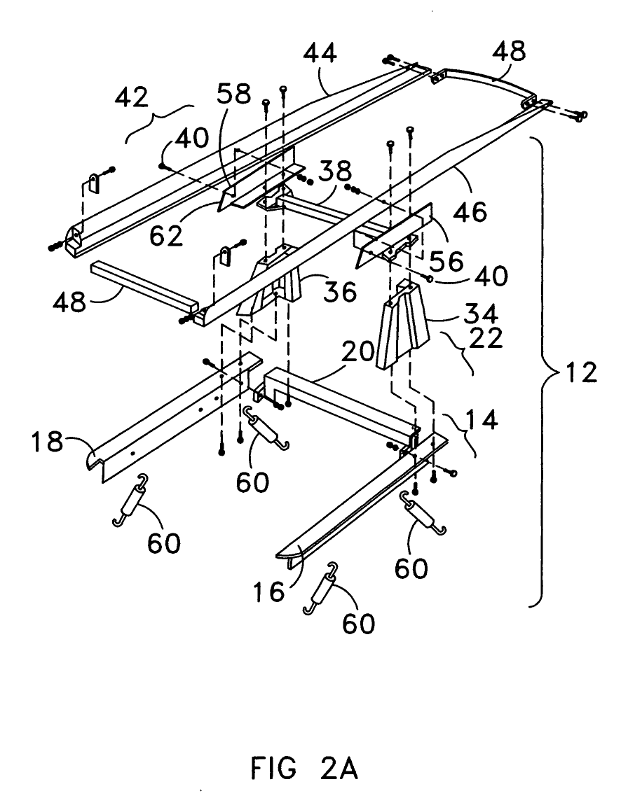

FIGS. 1A and 2A illustrates and shows the fixed frame being bolted together. One leg of the angle iron will set upon the sidewall and the other leg will extend downward on the inside of the sidewall. This arrangement provides stability in that the fixed frame 14 fits into the box of the truck and will not slip or slide sideways or forward. The downward extending leg of the angle iron secures the frame in place. The fixed frame 14 can be bolted to the sidewalls or held in place by turn buckles 60 or other securing apparatuses.

### Embodiment One

In the first embodiment of the two pivot point dump rack 10, a pair of pivot points 30 and 32 are located toward the rear of the side members 16 and 18. Typically, the pivot points are located on the leg of the angle iron that extends downward into the side walls of the pickup. But could be located elsewhere based upon the type of pivot being used. A bore with or without a bushing would be on the rear end of the side members 16 and 18. The bore would be for receiving a pivot pin 40 to pivotally attach the pivoting frame 22 to the fixed frame 14.

A pivoting frame 22 is pivotally attached to the fixed frame 14. In this embodiment, the pivoting frame 22 is the portion of the dumping rack that pivots and allows the rack to dump its load. In the preferred embodiment, the pivoting frame 22 has three sections or types of members. However, this is a typical configuration. Other similar configurations performing the same function would also function as the pivoting frame 22. In the preferred embodiment, a pair of side rails 24 and 26 forms the sides of the pivoting frame 22 and are pivotally attached to the side members 16 and 18 via pivot points 30 and 32. A bore with or without a bushing would be on the rear end of the side rail 24 and 26. The bore would be for receiving a pivot pin 40 to pivotally attach the pivoting frame 22 to the fixed frame 14. The pivot pin may be rigidly attached to either the fixed frame 14 or pivoting frame 22, or it could be fully rotatable depending on the type used. A forward cross rail 28 is attached to the forward ends of side rails 24 and 26. The pivoting frame 22 is sized to match the fixed frame. Typically, the side rails and the forward cross rail are made from angle iron. Such that, when in a lower position a leg of the angle iron extends downward inside of the fixed frame to provide stability and to prevent sideways motion of the pivoting frame in relation to the fixed frame.

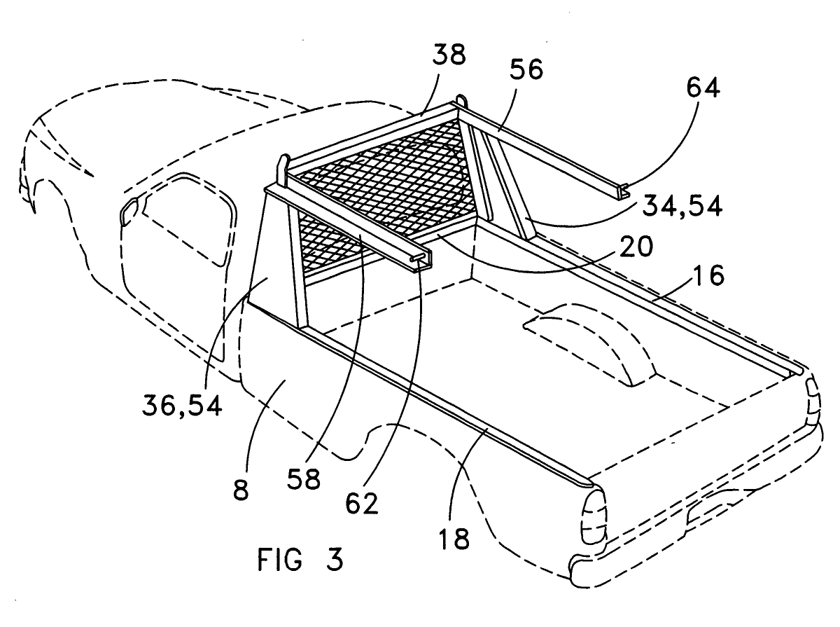

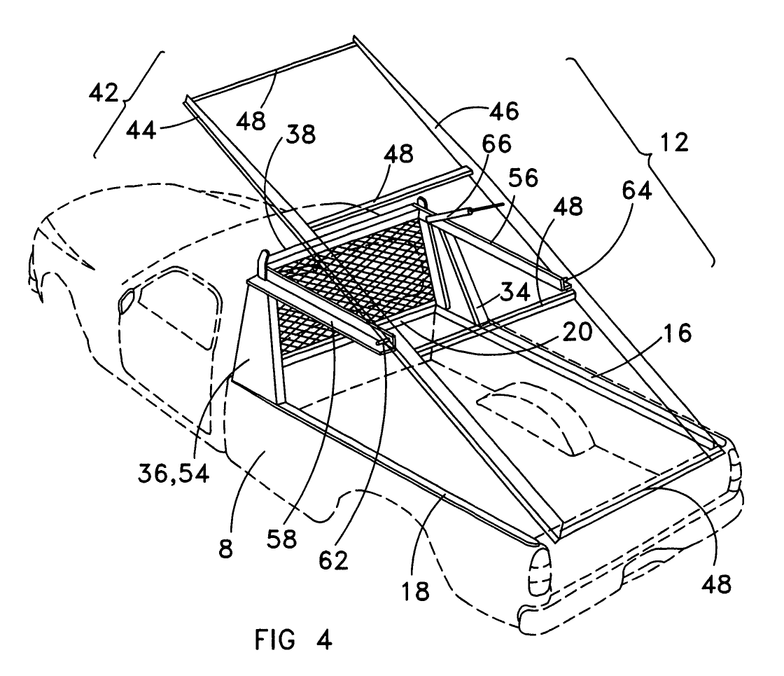

Upright supports 34 and 36 are perpendicularly and rigidly attached to forward ends of the side rails 24 and 26 on the pivoting frame 24. A lateral cross member or members 38 is/are typically attached between the upright supports 34 and 36 for stability and strength. The upright supports, in the preferred embodiment, are made from bent and formed plate steel. The bent steel plating provides strength and esthetics. The upright supports can also be made from many different material, combination of materials and in different configurations. As long as the function of the upright supports is fulfilled, any and all configurations and materials used are within the scope of this invention. Another configuration is an upright support 54 made with steel tubing. The steel tubing would be cut and positioned to support the dump rack 42 or longitudinal arms 56 and 58. The steel tubing could be bolted or welded in position. A steel plate 8 covering may be added for aesthetics. This is illustrated in FIGS. 3 and 4.

The dump rack 40 is rigidly attached to the top of upright supports 34 and 36, and/or 52, in this embodiment. The dump rack 40 consists of a frame having side members 44 and 46 and cross members 48. In the preferred embodiment the side members 44 and 46 are made from angle iron and the cross members 48 are made with steel tubing, but these could be made with other compatible materials and configurations. The side members 44 and 46 extend longitudinally and parallel to the sidewalls of the truck 8. There are at least two cross members 48. One would be located at the forward end and another at the rear end of the side members 44 and 46. These can be positioned at various locations as determined by a particular application. Other cross members may be added as needed or desired.

In this embodiment, the dump rack 42 is pivoted and tilted by raising and lowering the front of the pivoting frame 22. It is pivoted between a lower position and a raised position. This can be done manually or it can be assisted with dampers or actuators or some other sort of lifting mechanism 50. An electric, hydraulic, pneumatic or any other type of actuator or lift 50 can be used. An actuator 50 is illustrated in FIGS. 1 and 2. Typically, the actuator 50 would be installed between the side rails 24 and 26 and a brace 52 extending downward from the side members of the fixed frame 14.

### Embodiment Two

The second embodiment of the two pivot point dump rack 12 of this invention utilizes the exact same fixed frame 14, but without pivot points 30 and 32. In this embodiment, there is no pivoting frame 22.

Upright support members 34 and 36, and/or 54, as described above, are perpendicularly and rigidly attached to forward ends of the base members 16 and 18 on fixed frame 20. Lateral a cross member(s) 38 are typically attached between the upright supports 34 and 36 for stability and strength.

Longitudinal arms 56 and 58 are rigidly attached to the tops of the upright supports 34 and 36, and/or 54. The longitudinal arms 56 and 58 are attached so that they are parallel to the side members 16 and 18 on fixed frame 14. Typically, in the preferred embodiment the longitudinal arms 56 and 58 are made from angle iron, but could be constructed with any compatible materials and configurations. The length is determined by the particular application, considering the vehicle, length of the box, and length and position of the dump frame 42.

The dump rack 42 is pivotally attached to the longitudinal arms 56 and 58. A bore is located at a mid point on each of the side members 44 and 46 for pivotally attaching the dump rack to the longitudinal arms.

The pivot points 62 and 64 are located at a rear position on the longitudinal arms 56 and 58. A bore with or without a bushing would be on the rear end of the longitudinal arms 56 and 58. The bore would be for receiving a pivot pin 40 to pivotally attach the dump rack 42 to the longitudinal arms 56 and 58. The pivot pin may be rigidly attached to the longitudinal arms 56 and 58 or to the side members 44 and 46 on the dump rack 42, or it may be fully rotatable within the bores.

In this embodiment, the dump rack 42 pivots between a lower position where the side members' 44 and 46 of the dump rack 42 rest within or on the longitudinal arms 56 and 58, and a raised position to dump its load. The only moving part on this embodiment is the dump rack 42 rotating on pivot pins 40.

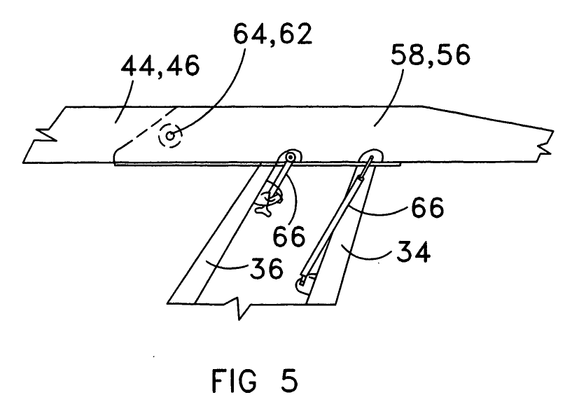

In this embodiment, only the dump rack 42 is pivoted and tilted by raising and lowering the front of the dump frame 42. As in embodiment one, this can be accomplished manually or assisted with dampers or actuators or some other sort of lifting mechanism 50. An electric, hydraulic, pneumatic or any other type of actuator or lifting mechanism can be used. A damping device is illustrated in FIG. 5. The damping device is attached to the dump frame 42 and upright supports 34.

The preferred embodiment and the best mode contemplated of the Two Pivot Point Dump Rack of the present invention are herein described. However, it should be understood that the best mode for carrying out the invention hereinafter described is offered by way of illustration and not by the way of limitation. It is intended that the scope of the invention includes all modifications which incorporate its principal design features.

Having described the invention in detail, those skilled in the art will appreciate that modifications may be made of the invention without departing from the spirit of the inventive concept herein described.

Therefore, it is not intended that the scope of the invention is limited to the specific and preferred embodiments illustrated and described. Rather, it is intended that the scope of the invention is determined by the appended claims and their equivalents.

What is claimed is:

1. A Two Pivot Point Dump Rack comprising:
a fixed frame attachable to a truck bed, the fixed frame having a pair of side members and a forward cross member rigidly attached to forward ends of the side members;
a pivot point on each of the side members towards a rear end of the side member;
a pivoting frame having a pair of side rails and a cross rail attached to a forward ends of the side rails, a rear end of each side rail pivotally attached to the pivot points on each of the side members, the pivoting frame pivoting between a lower position with the side rails resting upon the side members and an upper position with the forward end elevated above the fixed frame;
an upright support attached to and extending vertically upwards from a top forward end of each side rail on the pivoting frame; and
a dump rack having side members and one or more cross member(s), said dump frame rigidly attached to a top of the upright supports.

2. The Two Pivot Point Dump Rack as set forth in claim 1 further comprising a lifting mechanism, one end of said lifting mechanism attached to the side rails on the pivoting frame and another end of the lifting mechanism attached to the a brace extending from the fixed frame for pivoting the pivoting frame and the dump rack between a lower position and an upper position.

3. The Two Pivot Point Dump Rack as set forth in claim 2 in which the lifting mechanism comprises a damper, or an electric, hydraulic, pneumatic or any other type of actuator or lifting mechanism.

4. A Two Pivot Point Dump Rack comprising:
a fixed frame attachable to a truck bed, the fixed frame having a pair of side members and a forward cross member rigidly attached to forward ends of the side members;
an upright support attached to and extending vertically upwards from a forward end of each side member on the fixed frame;
longitudinal arms attached to the tops of the upright supports in a parallel relationship to the side members of the fixed frame;
a pivot point towards the rear of each of the longitudinal arms; and
a dump rack having side members and one or more cross member(s), said dump frame pivotally attached via the pivot points to the longitudinal arms.

5. The Two Pivot Point Dump Rack as set forth in claim 4 further comprising a lifting mechanism, one end of said lifting mechanism attached to the dump rack and another end of the lifting mechanism attached to the fixed frame or upright support, the lifting mechanism assisting in pivoting the dump rack between a lower position and an upper position.

6. The Two Pivot Point Dump Rack as set forth in claim 5 in which the lifting mechanism comprises a damper, or an electric, hydraulic, pneumatic or any other type of actuator or lifting mechanism.
